(19) United States
(12) Patent Application Publication
(10) Pub. No.: US 2006/0081762 A1
(43) Pub. Date: Apr. 20, 2006

(54) Extended life biopolymer array scanner system

(76) Inventors: John F. Corson, Mountain View, CA (US); Debra A. Sillman, Los Altos, CA (US); Harry E. Bunting, San Jose, CA (US); Kyle J. Schleifer, Los Gatos, CA (US); Jeffrey M. McMillan, Morgan Hill, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/288,750

(22) Filed: Nov. 28, 2005

Related U.S. Application Data
(63) Continuation of application No. 10/210,783, filed on Jul. 31, 2002.

(51) Int. Cl. G06F 19/00; G06K 9/00

(52) U.S. Cl. 250/205; 702/19; 382/128

(57) ABSTRACT

A biopolymer array optical scanner system that is configured to accommodate the needs of its working environment, but offer extended life over common scanners as typically used, is provided. The scanner is programmed to allow a user to set times or adopt a schedule by which the scanner will automatically power up and/or power down. The activity of the scanner can be controlled by setting a timer or selecting a given time/event, a custom schedule and/or a preselected schedule to trigger action by a software switch at the appointed time. The switch automatically takes such action as previously directed. The activity may be selected from powering up (turning on or going to standby), powering down (turning off or going to standby) and/or initiating a scan run. Myriad combinations or permutations of activities and their respective timing are possible.

### FIELD OF THE INVENTION

This invention relates to biopolymer array optical scanners.

### BACKGROUND OF THE INVENTION

Array assays between surface bound binding agents or probes and target molecules in solution are used to detect the presence of particular biopolymers. The surface-bound probes may be oligonucleotides, peptides, polypeptides, proteins, antibodies or other molecules capable of binding with target molecules in solution. Such binding interactions are the basis for many of the methods and devices used in a variety of different fields, e.g., genomics (in sequencing by hybridization, SNP detection, differential gene expression analysis, identification of novel genes, gene mapping, finger printing, etc.) and proteomics.

One-typical array assay method involves biopolymeric probes immobilized in an array on a substrate such as a glass substrate or the like. A solution containing analytes that bind with the attached probes is placed in contact with the array substrate, covered with another substrate such as a coverslip or the like to form an assay area and placed in an environmentally controlled chamber such as an incubator or the like. Usually, the targets in the solution bind to the complementary probes on the substrate to form a binding complex. The pattern of binding by target molecules to biopolymer probe features or spots on the substrate produces a pattern on the surface of the substrate and provides desired information about the sample. In most instances, the target molecules are labeled with a detectable tag such as a fluorescent tag or chemiluminescent tag. The resultant binding interaction or complexes of binding pairs are then detected and read or interrogated, for example by optical means, although other methods may also be used. For example, laser light may be used to excite fluorescent tags, generating a signal only in those spots on the biochip that have a target molecule and thus a fluorescent tag bound to a probe molecule. This pattern may then be digitally scanned for computer analysis.

As such, optical scanners play an important role in many array based applications. Optical scanners act like a large field fluorescence microscope in which the fluorescent pattern caused by binding of labeled molecules on the array surface is scanned. In this way, a laser induced fluorescence scanner provides for analyzing large numbers of different target molecules of interest, e.g., genes/mutations/alleles, in a biological sample.

The scanning equipment typically used for the evaluation of arrays includes a scanning fluorometer. A number of different types of such devices are commercially available from different sources, such as Perkin-Elmer, Agilent, or Axon Instruments, etc. Analysis of the data, (i.e., collection, reconstruction of image, comparison and interpretation of data) is performed with associated computer systems and commercially available software, such as Quantarray™ by Perkin-Elmer, Genepix Pro™ by Axon Instructions, Microarray Suite™ by Affymetrix, as well as Feature Extraction Software and Rosetta Resolver Gene Expression Data Analysis System, both available from Agilent.

In such devices, a laser light source generates a collimated beam. The collimated beam is focused on the array and sequentially illuminates small surface regions of known location on an array substrate. The resulting fluorescence signals from the surface regions are collected either confocally (employing the same lens used to focus the laser light onto the array) or off-axis (using a separate lens positioned to one side of the lens used to focus the laser onto the array). The collected signals are then transmitted through appropriate spectral filters, to an optical detector. A recording device, such as a computer memory, records the detected signals and builds up a raster scan file of intensities as a function of position, or time as it relates to the position. Such intensities, as a function of position, are typically referred to in the art as “pixels”. Biopolymer arrays are often scanned and/or scan results are often represented at 5 or 10 micron pixel resolution. To achieve the precision required for such activity, components such as the lasers must be set and maintained with particular alignment.

Generally, high precision machinery is costly. Accordingly, it is universally recognized that obtaining maximum life-span from such machinery with minimum down time for repair, refurbishment or replacement is important in realizing value. In addition, it is desirable from the perspective of worker or lab efficiency that down-time be minimized.

A common practice of those using array scanners is to always leave the system powered-up or “on.” The reason for taking such action is to ensure that the device is ready for use upon arrival of a new work shift. Many scanner systems require about 20 minutes to warm-up before they can be used. Unfortunately, in choosing not to power down or turn off a scanner system, certain components wear-out prematurely. Light sources (e.g. lasers), are among the first components to wear out.

Due to the optics and alignment issues involved in replacing a light source which must be taken into account for proper operation of a scanner, early replacement of such an item is particularly time consuming and costly. Accordingly, there exists a need for prolonging scanner life with respect to componentry that can be preserved by powering down a scanner. The present invention meets this need in a manner that can be reconciled with the usual practices for handling scanners in the work-place or in a research facility.

### SUMMARY OF THE INVENTION

The present invention provides software control for a scanner or optical imaging system and associated methodology for selectively programming the powered-up/on and powered-down/off states of a scanner. Various program options are possible as described in detail below. Generally, programming features may be provided to allow timing a given event, running a pre-set schedule, creating a schedule by which to run the power states of the machine, responding to a given or set interval of non-use and/or commencing operation at a given or set time. Further options are possible as well.

### BRIEF DESCRIPTION OF THE DRAWINGS

FIGS. 1 and 2 are decision trees showing optional actions for the inventive system as they may be related to each other.

FIG. 3 schematically illustrates an optical scanner as may be used in the present invention.

FIG. 4 is a front view of a packaged array that may be used in connection with the scanner of FIG. 3.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

A “biopolymer” is a polymer of one or more types of repeating units. Biopolymers are typically found in biological systems and particularly include polysaccharides (such as carbohydrates), peptides (which term is used to include polypeptides and proteins) and polynucleotides as well as their analogs such as those compounds composed of or containing amino acid analogs or non-amino acid groups, or nucleotide analogs or non-nucleotide groups. Biopolymers include polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. Biopolymers include DNA (including cDNA), PNA, oligonucleotides, and PNA and other polynucleotides as described in U.S. Pat. No. 5,948,902 and references cited therein (all of which are also incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (e.g., a single amino acid or nucleotide with two linking groups one or both of which may have removable protecting groups).

An “array,” includes any two-dimensional or substantially two-dimensional (as well as a three-dimensional) arrangement of addressable regions bearing a particular chemical moiety or moieties (e.g., biopolymers such as polynucleotide sequences (nucleic acids), polypeptides (e.g., proteins), etc.) associated with that region. In the broadest sense, the preferred arrays are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, photolithographic array fabrication processes are used. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse jets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used such as described in U.S. Pat. No. 5,599,695, U.S. Pat. No. 5,753,788, and U.S. Pat. No. 6,329,143. Interfeature areas need not be present particularly when the arrays are made by photolithographic methods as described in those patents.

An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probe” may be the one which is to be evaluated by the other (thus, either one could be an unknown mixture of polynucleotides to be evaluated by binding with the other). A “scan region” refers to a contiguous (preferably, rectangular) area in which the array spots or features of interest, as defined above, are found. The scan region is that portion of the total area illuminated from which the resulting fluorescence is detected and recorded. For the purposes of this invention, the scan region includes the entire area of the slide scanned in each pass of the lens, between the first feature of interest, and the last feature of interest, even if there exist intervening areas which lack features of interest. An “array layout” refers to one or more characteristics of the features, such as feature positioning on the substrate, one or more feature dimensions, and an indication of a moiety at a given location. “Hybridizing” and “binding”, with respect to polynucleotides, are used interchangeably.

By “remote location,” it is meant a location other than the location at which the array is present and hybridization occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. An array “package” may be the array plus only a substrate on which the array is deposited, although the package may include other features (such as a housing with a chamber). A “chamber” references an enclosed volume (although a chamber may be accessible through one or more ports). It will also be appreciated that throughout the present application, that words such as “top,” “upper,” and “lower” are used in a relative sense only.

A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “processor” references any hardware and/or software combination which will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

### DETAILED DESCRIPTION OF THE INVENTION

A biopolymer array optical scanner system that is configured to accommodate the needs of its working environment, but offer extended life over common scanners as typically used, is provided. The scanner is programmed to allow a user to set times or adopt a schedule by which the scanner will automatically power up and/or power down a set of components in the instrument. The activity of the scanner can be controlled by setting a timer or selecting a given time/event, a custom schedule and/or a preselected schedule to trigger action by a software switch at the appointed time. The switch automatically takes such action as previously directed. The activity may be selected from powering up (turning on or going to standby), powering down (turning off or going to standby) and/or initiating a scan run. Myriad combinations or permutations of activities and their respective timing are possible. The subject scanners find use in a variety of different applications, including genomic and proteomic applications.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

In describing the invention in greater detail than provided in the Summary and as informed by the Background and Definitions provided above, process or program aspects of the invention are first described. This discussion is followed by a description of suitable hardware for use in the invention and potential array use.

Methodology/Programming

As summarized above, the present invention involves software control for a scanner or optical imaging system, preferably a biopolymer array optical scanner, and associated methodology for selectively programming its powered-up/on and powered-down/off states. Another implementation allows for beginning a scan run. Any of these various actions (and intermediate steps in accomplishing the same) are automatically directed by the scanner. It is contemplated that any series or combination of such action may be effected by the scanner as well.

Highly complex routines may be developed to meet the specific needs of those in the workplace or laboratory. That is to say, programming and methodology according to the present invention is highly customizable. On the other hand, simplified operation is contemplated in which one-touch commands by a user will direct the scanner to take subsequent action.

In any case, the action selected is typically paired with a timing selection. The combination of directions of how to act and when to act provide adequate information for the processor of the system to carry out its commands.

A user will typically select from a number of timing options. These options may include choosing to run a particular pre-set schedule, defining his or her own schedule, choosing a single time for an event to occur or setting up a timer to have a particular action happen after some period of elapsed time.

Sometimes a user may choose to manually take certain action in controlling the scanner, i.e. control its action directly, while programming future events. For example, upon termination of a shift, a user might turn-off the scanner manually at that given instant and program a startup-up time for the next morning, or Monday morning in case it is Friday and no weekend activity is contemplated. Given adequate warm-up time after the scanner powers itself up, the scanner will be ready to operate upon the user's arrival.

A timer/action programmed scanner according to the present invention may be configured to offer complete flexibility in preselecting scanner activity. Yet, in certain instances it may be desired to only provide rudimentary functions to simplify use and/or avoid intimidating a user with a plethora of options.

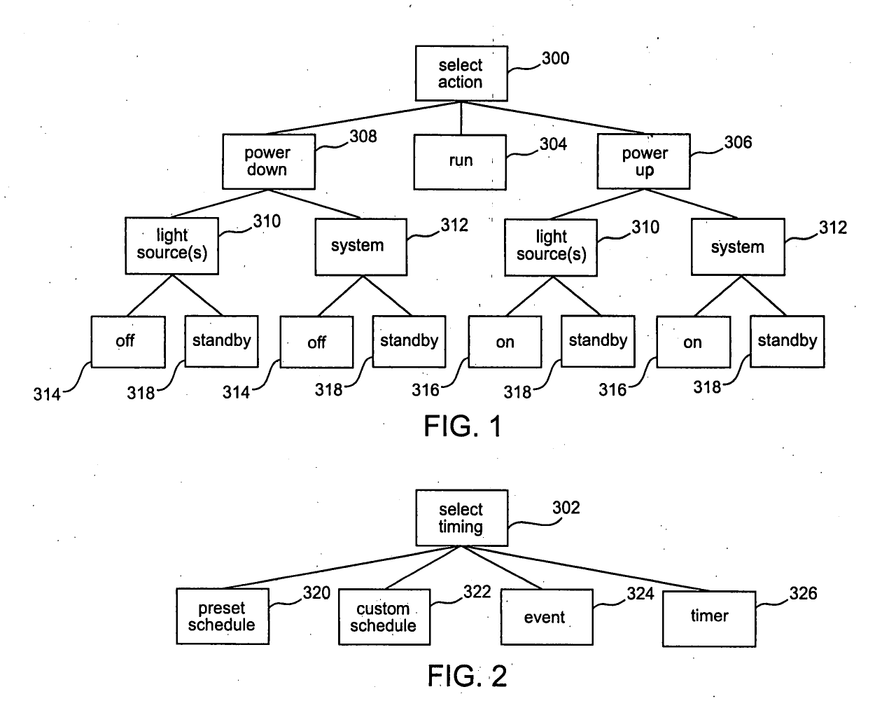

In any event, FIGS. 1 and 2 depict a number of approaches (or combinations thereof) that can be employed to increase scanner and scanner component life, especially excitation light sources, by programming tailored to avoid unnecessary power consumption and/or wear. FIG. 1 portrays a number of actions that may be taken, whereas FIG. 2 indicates potential timing selection in connection with such actions.

The order of operation in selecting the features shown in FIGS. 1 and 2 may occur in a sequential fashion by paging through one or more menus or be directly accessed via an input device 188, 194 (e.g., via a dedicated button) or otherwise. What is more, setting certain combinations of actions to run sequentially or simultaneously is possible.

In operation, a user will typically make an action selection 300 or a timing selection 302. In either case the selections will be coordinated. This may occur by following an action selection, with a timing selection, vice versa, by selecting an action with a pre-associated timing, or otherwise.

In a general sense, possible actions include setting the scanner system in operation or in a “run” mode 304, or switching a power state. Power up 306 and power down 308 states are contemplated. Either power state may involve a light source power switch 310 or a power switch of the system 312 (which may include action on the light sources or only other components). Whatever the hardware that is to be acted upon, specific actions may include turning the selected hardware to an “off” state 314, to an “on” state 316, and a “standby” state 318 (switching from full on to standby or from full off to standby).

Directing the system to run may first involve powering it up. In any case, the ability to direct commencement of scanning would allow a scientist to set-up scan features ahead of time, and wait for an array slide to be readied, loaded and scanned automatically later, possibly, by someone else.

Timing for any such action may be selected from a preset schedule 320. Such a schedule may control matters for a given day, cycling the system through various states, e.g., to account for changing shifts, lengthy scheduled breaks, etc. Typically, it will control matters for a given week, powering the system up and down for the beginning and end of a workday. Still further, the schedule selected could account for holidays and weekends or other non-work recurrent events or occasions.

To provide greater flexibility, programming for the system can be configured to allow a custom or customizable schedule 322. Allowing for such a feature, can optimize the advantages of the present invention by accounting even for the schedules of individual workers.

The timing selection made may also be of a simple event type 324. An event could be dictating a time or period of time in which an action 300 occurs or persists through. Programming a plurality of events could be viewed as setting forth a custom schedule. Another sort of event could be directing a power-down after running a complete set of (typically automated) scans.

In addition a timer condition 326 could be set. A preferred use for a timer function is to power-down the system or its laser(s) alone after a predetermined, user selected or preset period of inactivity.

Whatever the timing selection 302, the time at which action occurs may be regarded as “preselected” in that it precedes the action taken by some appreciable amount of time. That is to say, a user will not control action of the scanner immediately upon entering a command, but rather the command is set to act at a future point in time, likely when the user in absent. For example, one can program the scanner to turn the laser off when a scanning action, e.g., carousel run in the Agilent scanner, has been completed. Since scanning actions, such as carousel runs, can take many hours to complete, a user may start the run, program the scanner to turn laser off at the end of the scanning run, and then leave.

Another feature of the present invention is that controller 180 (or other ancillary hardware) may be configured with programming and memory to retain the content of a set of instructions for easy recall and repetition. Such memory features will be particularly useful in connection with custom schedules, event and user-dictated timer features.

Programming according to the present invention can be recorded on computer readable media, e.g. any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture that includes a recording of the present programming/algorithms for carrying out the above described methodology.

In certain embodiments, the system is further characterized in that it provides a user interface, where the user interface presents to a user the option of selecting among one or more different, including multiple different, rules for selecting a user-programmed schedule. Representative rules for selection that the user interface could present include, but are not limited to: a time period of no further scanning, a time of day, and completion of scanning one or more arrays, etc.

Optical Scanners

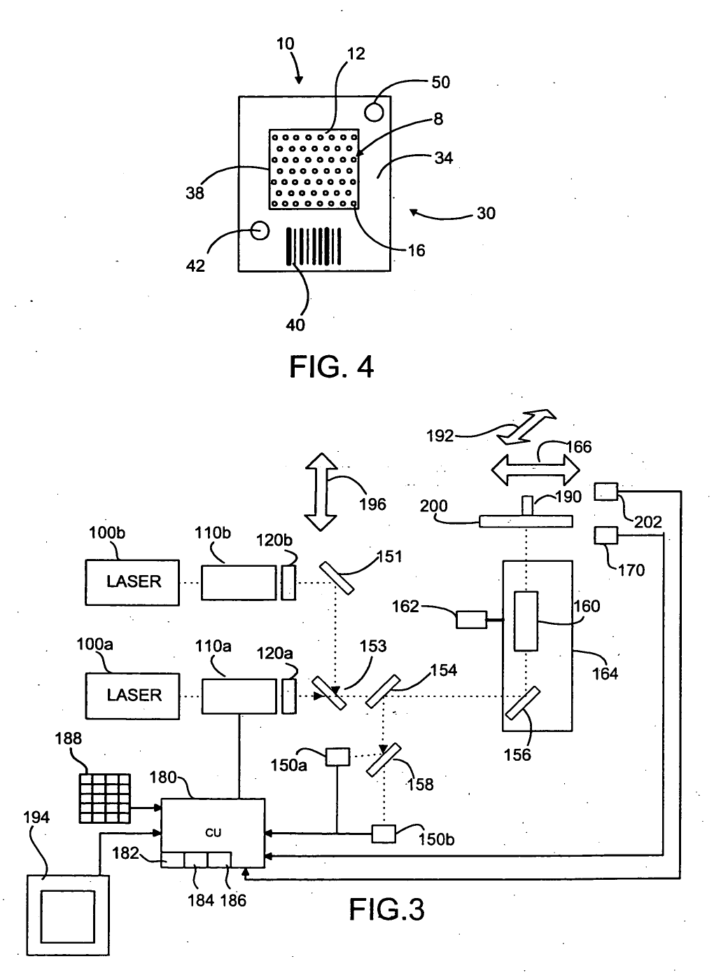

Also provided by the subject invention are biopolymer array optical scanners that are programmed as described above. Any biopolymer optical scanner or device may be provided to include the above programming. Representative optical scanners of interest include those described in U.S. Pat. Nos. 5,585,639; 5,760,951; 5,763,870; 6,084, 991; 6,222,664; 6,284,465; 6,329,196; 6,371,370 and 6,406,849—the disclosures of which are herein incorporated by reference. An exemplary optical scanner as may be used in the present invention is shown in FIG. 3.

A light system provides sample excitation light from an excitation light source, inlcuding a white light source, a laser, etc., where in many embodiments the excitation source is a laser, represented in the depicted system as element 100.

At least with respect to light produced by a laser, it passes through an electro-optic modulator (EOM) 110 with attached polarizer 120. Each laser 100a, 100b may be of different wavelength (e.g., one providing red light and the other green) and each has its own corresponding EOM 110a, 110b and polarizer 120a, 120b. The beams may be combined along a path toward a holder or caddy 200 by the use of fold mirror 151 and dichroic mirror 153. A control signal in the form of a variable voltage applied to each corresponding EOM 110a, 110b by the controller (CU) 180, changes the polarization of the exiting light which is thus more or less attenuated by the corresponding polarizer 120a, 120b. Controller 180 may be or include a suitably programmed processor. Thus, each EOM 110 and corresponding-polarizer 120 together act as a variable optical attenuator which can alter the power of an interrogating light spot exiting from the attenuator.

The remainder of the light from both lasers 100a, 100b is transmitted through a dichroic beam splitter 154, reflected off fully reflecting mirror 156 and focused onto either an array (not shown) mounted on holder 200, or a calibration member (not shown), whichever is at a reading position, using optical components in beam focuser 160. Light emitted (in particular, fluorescence) at two different wavelengths (e.g., green and red light) from features 16, in response to the interrogating light, is imaged using the same optics in focuser/scanner 160, and is reflected off mirrors 156 and 154. The distinct excitation sources are aligned such that the emitted fluorescence passes through a further dichroic mirror 158 and are passed to respective detectors 150a and 150b.

More optical components (not shown) may be used between the dichroic and each detector 150a, 150b (such as lenses, pinholes, filters, fibers, etc.) and each detector 150a, 150b may be of various different types (e.g., a photo-multiplier tube (PMT) or a CCD or an avalanche photodiode (APD)). All of the optical components through which light emitted from an array or calibration member in response to the illuminating laser light, passes to detectors 150a, 150b, together with those detectors, form a detection system. A scan system causes the illuminating region in the form of a light spot from each laser 100a, 100b, and a detecting region of each detector 150a, 150b (which detecting region will form a pixel in the detected image), to be scanned across multiple regions of an array or an array package mounted on holder 200.

The scanned regions for an array will include at least its multiple probe features. The scanning system is typically a line by line scanner, scanning the interrogating light in a line across an array as described below when at the reading position, in a direction of arrow(s) 166, then moving (“transitioning”) the interrogating light in a direction into/out of the paper as depicted by arrow(s) 192 as viewed in FIG. 3 to a position at an end of a next line, and repeating the line scanning and transitioning until the entire array has been scanned. In other modes the scanner rescans the same line in the opposite direction before transitioning, as described in copending application Ser. No. ______ (attorney docket no. 10020059) entitled Array Scanner Noise Reduction filed on even date herewith.

This scanning feature is accomplished by providing a housing 164 containing mirror 158 and focuser 160, which housing 164 can be moved along a line of pixels (i.e., from left to right or the reverse as viewed in FIG. 5) by a transporter 162. The second direction 192 of scanning (line transitioning) can be provided by second transporter which may include a motor and belt (not shown) to move caddy 200 along one or more tracks. The second transporter may use a same or different actuator components to accomplish coarse (a larger number of lines) movement and finer movement (a smaller number of lines). Generally, directly adjacent rows are scanned. However, “adjacent” rows may include alternating rows or rows where more than one intervening row is skipped.

The scanner of FIG. 3 may further include a reader (not shown) to read an identifier from an array package. Such an identifier may be in the form of a bar code that can be read by a suitable bar code reader.

Of course, the movements 166 and 192 may be accomplished by actuating holder 200 or housing 164 alone. Still further, the movement roles described for each element above may be swapped.

An autofocus detector 170 is generally provided to sense any offset (variation in slope) between different regions of array 12 when in the reading position, and a determined position of the focal plane of the detection system. The autofocus system includes detector 170, processor 180, and a motorized or servo-controlled adjuster 190 to move holder 200 in the direction of arrow 196 to establish correct focus for the system. The detector may directly detect a partial reflection from another beamsplitter (not shown) between splitters 153 and 154. In addition, a second position detector 202, also feeding back to the CU, preferably measures the absolute position (i.e., relative to the apparatus) of the servo-controlled adjuster 190). As above with respect to movements 166 and 192, it should be observed that focus servo control movement indicated by arrows(s) 196 may occur in connection with housing 164 instead of the holder. Further details regarding suitable chemical array autofocus hardware is described in pending U.S. patent application Ser. No. 09/415,184 for “Apparatus And Method For Autofocus” by Dorsel, et al., filed Oct. 7, 1999, the disclosure of which is herein incorporated by reference, as well as European publication EP 1091229 published Apr. 11, 2001 to the same title and inventors—the disclosure of the priority document of which is herein incorporated by reference. In addition, details regarding maintaining or setting lens focus upon changing direction may be appreciated in reference to U.S. patent application Ser. No. 10/087,220, entitled “Bi-Directional Scanner Control System,” filed Feb. 28, 2001 which provides algorithms to account for variability in assay slide slope—the disclosure of which is herein incorporated by reference.

In any case, array orientation and configuration is of little consequence since focus can be set to probe features either directly, or looking through a transparent substrate medium if the array is inverted for scanning.

Controller 180 of the apparatus is connected to receive signals from detectors 150a, 150b, these different signals corresponding to different “channels,” i.e., signals which result at each of the multiple detected wavelengths from emitted light for each scanned region of an array when at the reading position mounted in holder 200. Controller 180 also receives the signal from autofocus offset detector 170 and absolute servo position detector 202, and provides the control signal to EOM 110, and controls the scan system. Controller 180 may also analyze, store, and/or output data relating to emitted signals received from detectors 150a, 150b in a known manner.

Controller 180 may include a computer in the form of a programmable digital processor, and include a media reader 182 which can read a portable removable media (such as a magnetic or optical disk), and a communication module 184 which can communicate over a communication channel (such as a network, for example the internet or a telephone network) with a remote site (such as a database at which information relating to array package 30 may be stored in association with the identification 40).

The controller is suitably programmed to execute all of the steps required by it during operation of the apparatus, as discussed further below. Alternatively, controller 180 may be any hardware or hardware/software combination which can execute those steps.

In any case controller 180 includes a software controllable switch 186 that functions according to programming as described above to power-up or turn on any or all lasers, as well as other components of the scanner, e.g., detectors (such as PMT detectors), etc., and power-down or turn off upon command. As such, the switch may power up or down other scanner components as well, even the entire scanner—with the possible exception of the controller switch so that it may turn everything back on at a predetermined time. Regardless, powering-down the light sources or other equipment may involve actually turning off the power, or it may involve sending the component(s) into a reduced power (and wear) stand-by mode. Similarly, powering-up the components may involve setting the components to a stand-by mode or to an operative state.

To make selections to dictate switch function, an input device 188 in the form of a keypad or keyboard may be provided. This may be a dedicated device or serve a number of input purposes. Alternately, input functions may be provided in connection with a touchscreen monitor 194 that could also be used to display data results and/or directions for use.

Utility

The subject biopolymer optical scanners find use in a variety of applications, where such applications are generally analyte detection applications in which the presence of a particular analyte in a given sample is detected at least qualitatively, if not quantitatively. Protocols for carrying out array assays are well known to those of skill in the art and need not be described in great detail here. Generally, the sample suspected of comprising the analyte of interest is contacted with an array under conditions sufficient for the analyte to bind to its respective binding pair member that is present on the array. Thus, if the analyte of interest is present in the sample, it binds to the array at the site of its complementary binding member and a complex is formed on the array surface. The presence of this binding complex on the array surface is then detected, e.g., through use of a signal production system such as a fluorescent label present on the analyte, etc, where detection includes scanning with an optical scanner according to the present invention. The presence of the analyte in the sample is then deduced from the detection of binding complexes on the substrate surface.

Specific analyte detection applications of interest include hybridization assays in which the nucleic acid arrays of the subject invention are employed. In these assays, a sample of target nucleic acids is first prepared, where preparation may include labeling of the target nucleic acids with a label, e.g., a member of signal producing system. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced using the subject arrays include: gene discovery assays, differential gene expression analysis assays; nucleic acid sequencing assays, and the like. References describing methods of using arrays in various applications include U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992—the disclosures of which are herein incorporated by reference.

Where the arrays are arrays of polypeptide binding agents, e.g., protein arrays, specific applications of interest include analyte detection/proteomics applications, including those described in U.S. Pat. Nos. 4,591,570; 5,171,695; 5,436,170, 5,486,452; 5,532,128 and 6,197,599 as well as published PCT application Nos. WO 99/39210; WO 00/04832; WO 00/04389; WO 00/04390; WO 00/54046; WO 00/63701; WO 01/14425 and WO 01/40803—the disclosures of which are herein incorporated by reference.

An example array is presented in FIG. 4. Array 10 carries multiple probe features 16 disposed across a surface of the substrate 12 upon which the array is formed. The substrate is preferably in the form of a contiguous, substantially planar substrate made of transparent material to facilitate data acquisition scanning there through. Alternatively, the substrate could be scanned from the side which carries features 16. Features 16 (not to scale) are shown disposed in a pattern which defines the array. The extent of the pattern defines a scan region 8.

Array 10 may be set within a housing 34 to provide an array package 30. In which case, substrate 10 is sealed (such as by the use of a suitable adhesive) to housing 34 around a margin 38. Housing 34 is configured such that housing 34 and substrate 12, define a chamber into which features 16 of the array face. This chamber is accessible through resilient septa 42, 50 which define normally closed ports of the chamber. An identifier 40, possibly in the form of a bar code, may be affixed to housing 34. The above description is merely exemplary of a package design that may be employed, where other package designs are known and may be used, including the package design sold by Agilent for use in its G2565AA Microarray Scanner System. The composition of the probe features and material(s) used to produce elements of the array package may vary, but may be as typical in the art.

In using an array in connection with a programmed scanner according to the present invention, the array will typically be exposed to a sample (such as a fluorescently labeled analyte, e.g., protein containing sample) and the array then read. Reading of the array may be accomplished by illuminating the array and reading the location and intensity of resulting fluorescence at each feature of the array to detect any-binding complexes on the surface of the array.

It is further noted that aspects of the invention may be applicable to a variety of optical scanners including those that detect chemiluminescent or electroluminescent labels. The present invention will be applicable to such scanners where powering down the scanner will result in lifetime savings, as exemplified above.

In any case, results from reading an array may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing). Stated otherwise, in certain variations, the subject methods may include a step of transmitting data from at least one of the detecting and deriving steps, to a remote location. The data may be transmitted to the remote location for further evaluation and/or use. Any convenient telecommunications means may be employed for transmitting the data, e.g., facsimile, modem, internet, etc.

Kits

Kits for use in connection with the subject invention may also be provided. Such kits preferably include at least a computer readable medium including programming as discussed above and instructions. The instructions may include installation or setup directions. The instructions may include directions for use of the invention with options or combinations of options as described above. In certain embodiments, the instructions include both types of information.

Providing the software and instructions as a kit may serve a number of purposes. The combination may be packaged and purchased as a means of upgrading an existing scanner. Alternately, the combination may be provided in connection with a new scanner in which the software is preloaded on the same. In which case, the instructions will serve as a reference manual (or a part thereof) and the computer readable medium as a backup copy to the preloaded utility.

The instructions are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging), etc. In other embodiments, the instructions are present as an electronic storage data file present on a suitable computer readable storage medium, e.g., CD-ROM, diskette, etc, including the same medium on which the program is presented.

In yet other embodiments, the instructions are not themselves present in the kit, but means for obtaining the instructions from a remote source, e.g. via the Internet, are provided. An example of this embodiment is a kit that includes a web address where the instructions can be viewed and/or from which the instructions can be downloaded. Conversely, means may be provided for obtaining the subject programming from a remote source, such as by providing a web address. Still further, the kit may be one in which both the instructions and software are obtained or downloaded from a remote source, as in the Internet or world wide web. Some form of access security or identification protocol may be used to limit access to those entitled to use the subject invention. As with the instructions, the means for obtaining the instructions and/or programming is generally recorded on a suitable recording medium.

The following examples are offered by way of illustration and not by way of limitation.

### Experimental

In an Agilent scanner as referenced above (but one that does not include the features of the present invention), a user has two options in managing the operation of the device. The user may leave the instrument on all of the time, in which case laser lifetime is being used up constantly. This action limits the instrument's lifetime (as characterized above) to the real elapsed time that the user has had the instrument. Another option would be to turn off the unit before leaving for the day. However, such action is rarely taken since it has the disadvantage that whenever the next shift begins, the user must wait at least 20 minutes for the instrument to warm up (because of the warm-up time of the light sources used). While this time may vary for other instruments with other light sources, it is common to have to wait for the excitation light source warm-up in order for the light source(s) to gain stability in intensity and direction.

According to the present invention, a user may instead choose to have the lasers turned off on a predetermined, fixed schedule. Thus, for example, if the user runs an 9 hour shift from 9 am to 6 pm, he or she could have the laser(s) power-down at 5:30 pm and turn back on at 8:30 am. This opportunity provides the system enough time to warm-up before the user starts the next shift and also gives some leeway in departure time, thereby accounting for workplace realities. Such an example regimen will extend instrument lifetime by more that about 250% as compared to the scanner always being on. Further, it will conserve energy.

Another example is a modification of the Agilent G2565AA Microarray Scanner system in which the scanner is programmed such that upon completion of a carousel run, which can take several hours, the scanner automatically powers down. The scanner may be further programmed to turn on after a set period of time following the above described power down, or at a preselected time, e.g., 0.5 hours prior to the beginning of the next shift.

Though the invention has been described in reference to one example, optionally incorporating various features, the invention is not to be limited to that specifically described. It is to be understood that the breadth of the present invention is to be limited only by the literal or equitable scope of the following claims.

It is evident from the above discussion that the above described invention provides an effective and readily applicable way to extend the lifetime of optical scanners. As such, the subject invention represents a significant contribution to the art.

All publications and patents cited in this specification are herein incorporated by reference as if each individual publication or patent were specifically and individually indicated to be incorporated by reference. The citation of any publication is for its disclosure prior to the filing date and should not be construed as an admission that the present invention is not entitled to antedate such publication by virtue of prior invention.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

1. A biopolymer array optical scanner system programmed to control power to at least one light source of said system for at least one predetermined time and to scan a light across a region of an array surface.

2. The system of claim 1, wherein said at least one predetermined time corresponds to a pre-programmed schedule.

3. The system of claim 1, wherein said at least one predetermined time corresponds to a user-programmed schedule.

4. The system of claim 1, wherein said system has a user interface which presents to a user the option of selecting among multiple different rules for selecting a user-programmed schedule.

5. The system of claim 4, wherein said multiple different rules include a time period of no further scanning, a time of day, and completion of scanning one or more arrays.

6. The system of claim 1, wherein said at least one predetermined time corresponds to a selected event.

7. The system of claim 1, wherein said at least one predetermined time corresponds to a selected elapsed time of system non-use.

8. The system of claim 1, wherein said system is programmed to power down said at least one light source.

9. The system of claim 8, wherein said power down is an off state.

10. The system of claim 8, wherein said power down is a standby state.

11. The system of claim 1, wherein said system is programmed to power up said at least one light source.

12. The system of claim 11, wherein said power up is an on state.

13. The system of claim 11, wherein said power up is a standby state.

14. The system of claim 1, wherein said system is programmed to control power to an entirety of said system.

15. The system of claim 1, wherein said at least one light source comprises at least one laser.

16. A computer-readable medium comprising a program that controls power to at least one light source of a biopolymer array optical scanner system for at least one predetermined time and scans a light across a region of an array surface.

17. The computer readable medium according to claim 16, wherein said program provides a user interface which presents to a user the option of selecting among multiple different rules for selecting a user-programmed schedule.

18. The computer readable medium of claim 17, wherein said multiple different rules include a time period of no further scanning, a time of day, and completion of scanning one or more arrays.

19. A method of operating a biopolymer array optical scanner system, said method comprising:
a user selecting and entering into said scanner system at least one predetermined time to control power to at least one light source of the system; and
a software switch controlling power to said at least one light source upon said at least one predetermined time;
wherein said system scans a light across a region of array surface.

20. A method of assaying a sample, said method comprising:
contacting said sample with a biopolymeric array of two or more biopolymer ligands immobilized on a surface of a solid support; and
reading said array with a biopolymer array optical scanner according to claim 1 to obtain a result.

21. The method of claim 20, wherein said biopolymer array is chosen from a polypeptide array and a nucleic acid array.

22. The method of claim 21, further comprising transmitting said result from a first location to a second location

23. The method of claim 22, where said second location is a remote location

24-25. (canceled)
